(19) United States
(12) Patent Application Publication
(10) Pub. No.: US 2007/0241930 A1
(43) Pub. Date: Oct. 18, 2007

(54) Automatic Meter-Reading Interface for Fluid Sensing Meters

(75) Inventors: Khurshid Qureshi, Colorado Springs, CO (US); Scott Gruber, Colorado Springs, CO (US)

Correspondence Address: LEE & HAYES, PLLC, 421 W. RIVERSIDE AVE, STE 500, SPOKANE, WA, 99201, US

(73) Assignee: zeeWAVES, Colorado Springs, CO (US)

(21) Appl. No.: 11/735,159

(22) Filed: Apr. 13, 2007

Related U.S. Application Data
(60) Provisional application No. 60/792,890, filed on Apr. 18, 2006.

(51) Int. Cl. G08C 15/06

(52) U.S. Cl. 340/870.02

(57) ABSTRACT

An automatic meter-reading interface for a fluid sensing meter is described. In one aspect, an Automatic Meter-Reading enabling shroud (AES) encapsulates the interface. The AES is for positioning below a register and above a rotating disc magnet in a fluid meter such that a pre-existing operational relationship between the rotating disc magnet and the register is maintained. The AES includes at least one magnetic switch coupled to a microcontroller to calculate a total volume of fluid that has passed through the fluid meter over a configurable period. This calculation is based on the at least one magnetic switch periodically sensing North and South magnetic fields from the rotating disc magnet; each sensed field indicating a predetermined per-unit volume of fluid passing through the fluid meter. The AES generates a pulse indicating the total volume of fluid for interrogation by an AMR device.

### RELATED APPLICATION

This patent application claims priority to U.S. provisional patent application Ser. No. 60/792,890 filed on Apr. 18, 2006, titled “A Fluid Metering Sensing System Module”, which is hereby incorporated by reference.

### BACKGROUND

Automatic Meter-Reading (AMR) System automatically collects data from AMR-enabled utility metering devices (e.g., water, gas, electric), generally transmitting by RF wireless the collected data to a central database for billing and/or analyzing. AMR technologies include, for example, handheld, mobile and network technologies based on telephony platforms (wired and wireless), radio frequency (RF), or power line transmission. To transmit such data, AMR devices typically use pulse or encoder registers that produce electronic output for radio transmission to reading storage and data logging devices. Pulse registers send a digital or analog electronic pulse to a recording device. Encoder registers have an electronic means for an external device to interrogate the register for either the position of the odometer wheels or stored electronic reading. Some AMR meter registers include an LCD display.

FIG. 1 shows an exemplary stack up of a legacy energy-metering device 100 that is not AMR-enabled. Such legacy metering devices 100 are common in residential and commercial developments. An exemplary such legacy metering device uses the physics principle of Faraday's law of induction to measure fluid flow with electromagnets. For example, and referring to FIG. 1, legacy device 100 includes an upper shroud 102, a mechanical or an electrical register 104, and a lower shroud 106 that separates rotating disc magnet 108 from mechanical register 104. Each rotation of the magnet 108 indicates a per-unit volume of fluid passing through the fluid metering device. Mechanical register 104 typically includes a dial similar to a clock with gradations around the parameter to indicate water usage, and a set of odometer wheels, to display total energy usage, for example, in US gallons, cubic feet or cubic meters. To obtain energy usage readings from such legacy meters, a human being typically visits and physically views the meter's register directly at the meter location. Such manual meter reading operations are time-consuming, labor-intensive and costly. A utility company can generally reduce costs associated with such legacy energy-meter reading activities by using AMR-ready energy meters. However, replacing non-AMR based energy meters with AMR ready energy meters can be very cost prohibitive, often requiring substantial capital expense.

### SUMMARY

An automatic meter-reading interface for a fluid sensing meter is described. In one aspect, an Automatic Meter-Reading enabling shroud (AES) encapsulates the interface. The AES is for positioning below a register and above a rotating disc magnet in a fluid meter such that a pre-existing operational relationship between the rotating disc magnet and the register is maintained. The AES includes at least one magnetic switch coupled to a microcontroller to calculate a total volume of fluid that has passed through the fluid meter over a configurable period. This calculation is based on the at least one magnetic switch periodically sensing North and South magnetic fields from the rotating disc magnet inside the water meter; each sensed field indicating a predetermined per-unit volume of fluid passing through the fluid meter. The AES generates a pulse indicating the total volume of fluid for interrogation by an AMR device.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures and associated description, the left-most digit of a component reference number identifies the particular Figure in which the component first appears.

FIG. 1 shows an exemplary stack up of a legacy energy-metering device that is not AMR-enabled.

FIG. 2 shows an exemplary stack-up of an AMR-enabled fluid meter, according to one embodiment.

FIG. 3 shows further aspects of the exemplary AMR-enabled fluid meter of FIG. 2, according to one embodiment.

FIG. 4 shows an exemplary circuit diagram and microcontroller configuration of an AMR-enabled fluid meter, according to one embodiment.

FIG. 5 shows an flow diagram for exemplary process to generate an AMR-enabled fluid meter from a previously non-AMR-enabled fluid meter, according to one embodiment.

FIG. 6 shows an exemplary procedure for a universal AMR interface for fluid meters, according to one embodiment.

FIG. 7 shows an exemplary universal AMR interface for fluid meters with an electronic touch-sensitive LCD register, according to one embodiment.

### DETAILED DESCRIPTION

### Overview

A Universal AMR Interface (UAI) for fluid sensing meters is described. The UAI converts legacy fluid meters (e.g., water, gas, etc.) that are not AMR-ready and that use electromagnetic induction to measure flow, to AMR-enabled meters. The UAI includes one or multiple magnetic sensors (such as reed switches or Hall Effect Sensors) coupled to a microcontroller, an energy source, and electronics and such as transistors to determine, store, and transmit information associated with volumes of fluid flow for subsequent collection by conventional AMR technologies. In one implementation, an AMR-enabling shroud (AES) encapsulates the UAI and replaces a standard lower shroud in a non-AMR-enabled fluid meter (a “legacy fluid meter”) to create an AMR-ready meter. To this end, the AES is configured and positioned such that magnetic sensors in the UAI are positioned directly above a rotating disc magnet in the meter housing and underneath the meter's pre-existing mechanical or electrical register. This positioning maintains the pre-existing register's operational coupling to the rotating disc magnet, rotations of which correlate to a per-unit fluid flow through the meter. In another implementation, the AES also provides an electronic register to replace the preexisting register. Is such an implementation, information associated with measured fluid flow is presented to a viewer, for example, via an operatively coupled LCD

To measure fluid flow, and responsive to detecting magnetic poles from the rotating disc magnet, the magnetic sensors in the UAI periodically wake-up the microcontroller to calculate and persist (in a computer-readable storage medium) fluid volume flow data. In one implementation, the UAI is also configured to determine, process, and persist additional information associated with event alarms, tampering, leak detection, low battery, reverse flow, etc. for water or energy use profiling, time of use billing, demand forecasting, rate of flow recording, leak detection, flow monitoring, etc. The UAI transmits at least a subset of such data via electronic pulses for collection by one or more conventional and arbitrary AMR technologies. The UAI is universal because it is programmable (e.g., via a serial port, etc.) for compatibility with multiple such AMR technologies including, for example, touch-based AMR, radio frequency AMR, handheld AMR, mobile AMR, fixed network AMR, and/or so on. In this manner, the UAI converts a conventional non-AMR based fluid meter to an AMR-enabled fluid meter without replacing the legacy mechanical or electrical register. Alternatively, the UAI also provides an electrical register to replace the preexisting mechanical or electrical register.

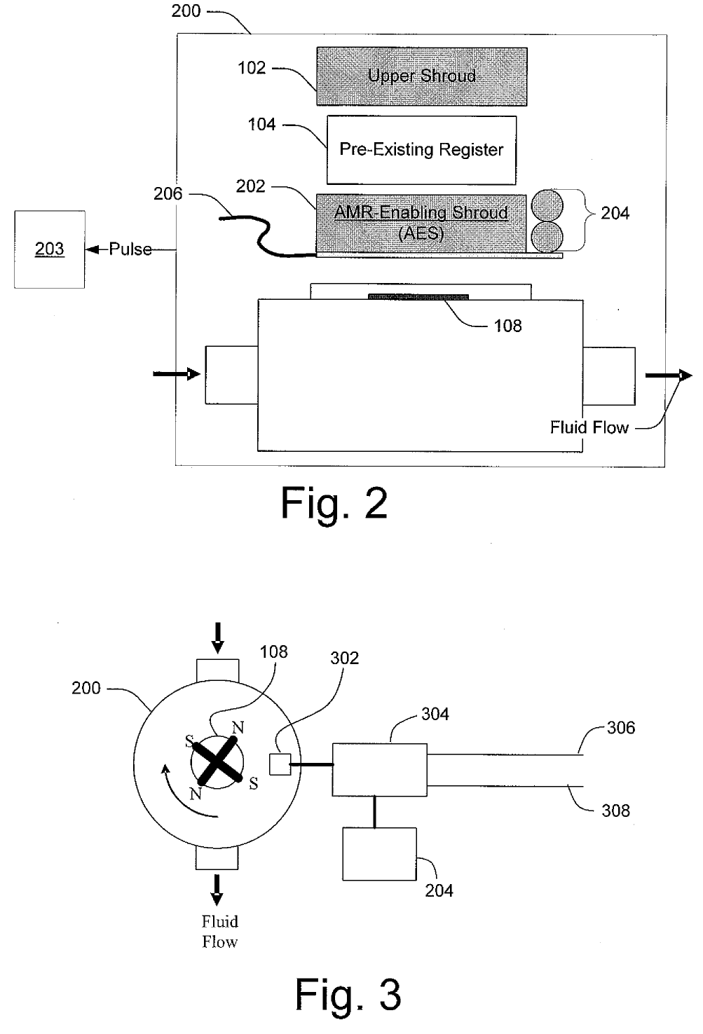

These and other aspects of the UAI for fluid sensing meters are described in greater detail below in reference to FIGS. 2 through 6.

### An Exemplary System

Although not required, the UAI for fluid sensing meters is described in the general context of a combination of fluid metering hardware and computer-executable instructions executed by a computing device such as a microcontroller. Program modules generally include routines, programs, objects, components, data structures, etc., that perform particular tasks or implement particular abstract data types. While the systems and methods are described in the foregoing context, acts and operations described hereinafter may also be completely implemented in hardware.

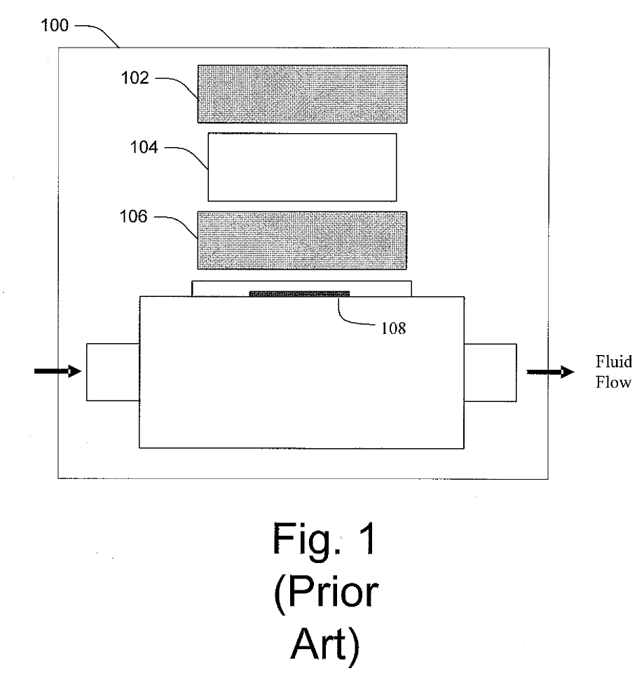

FIG. 2 shows an exemplary stack-up of an AMR-enabled fluid meter 200, according to one embodiment. For purposes of exemplary description, aspects of fluid meter 200 are described with respect to aspects of FIG. 1. In the description, the left-most numeral of a drawing component indicates the particular drawing where the component was first introduced. Referring to FIG. 2, fluid meter 200 measures quantities of fluid flow (water, gas, etc.) via electromagnetic induction and provides information associated with such measurements to an AMR. As described above in the section titled “Overview”, the AMR-enabled fluid meter 200 represents a legacy non-AMR-ready fluid meter that has been modified with an AMR-enabling shroud (AES) 202 in a manner that either maintains operability of the pre-existing register, or in another implementation, replaces the pre-existing register with electric register. AES 202 is a fluid metering sensing system module, or modular component.

Specifically, fluid meter 200 is configured to capture, store, process and transmit data associated with the measured quantities of fluid to an AMR device 203. As shown, fluid meter 200 includes an upper shroud 102 (please also see FIG. 1), a pre-existing register 104, and a novel UAI enabling shroud (“AES”) 202. To achieve this configuration, for example, a technician disassembles the following components from a legacy water meter 100: the upper shroud 102, the pre-existing register 104 and the lower shroud 106 (please see FIG. 1). To achieve fluid meter 200, the technician then replaces lower shroud 106 (FIG. 1) with AES 202, and reassembles the pre-existing register 104 and upper shroud 102, as shown.

AES 202 is a customized shroud that contains (or otherwise supports) one or more magnetic sensors (shown in FIG. 3), one or more microcontrollers (shown in FIGS. 3, 4, and 5), one or more batteries 204, and signal wires 206 for operative coupling to the AMR. In one implementation, AES 202 is a waterproof shroud (e.g., the electronics are over-molded in modular form and assembled to plastic shroud, etc.) for pit, outdoor, and/or other installation environments subject to moist/wet conditions. The magnetic sensor(s) are activated responsive to rotation of the rotating disc magnet 108. Such activation triggers fluid measurement processes of the microcontroller(s) to send electronic pulses of digital data across signal wires 206 for detection by external AMR. In this implementation, thickness of interface enabling shroud 202, wherein such thickness is a function of a minimal thickness of the magnetic sensors, does not affect the original operational relationship between rotating disc magnet I 08 and a pre-existing mechanical or electrical register 104.

FIG. 3 shows further aspects of the exemplary AMR-enabled fluid meter 200 of FIG. 2, according to one embodiment. For purposes of exemplary description, aspects of fluid meter 200 of FIG. 3 are described with respect to aspects of FIGS. 1 and 2. In the description, the left-most numeral of a drawing component indicates the particular drawing where the component was first introduced. Referring to FIG. 3, fluid meter 200 includes rotating disc magnet 108, one or more magnetic sensors 302 (e.g., switches 302-1 and 302-2), one or more microcontrollers 304, one or more energy sources (e.g., batteries 204, or a different power source), and signal lines 306 and 308. Signal lines 306 and 308 collectively represent signal lines 204 of FIG. 2. Rotating disc magnet 108 rotates based on the volume of fluid that passes through the meter 200.

A magnetic switch 302 closes whenever a North or South pole associated with rotating disc magnet 108 is sensed by the magnetic switch 302. In one implementation, a magnetic switch 302 is a conventional Reed switch. In another implementation, a magnetic sensor 302 is based on Hall effects. Closing of magnetic sensor 302 wakes-up microprocessor 304, responsive to which microprocessor 304 increments a count of rotations associated with rotating disc magnet 108. Microprocessor 304 uses a conversion of “counter” rotations to unit volumes of fluid to calculate a volume of fluid that has passed through fluid meter 200 during a configurable period. Responsive to receiving a query from a conventional AMR unit, microcontroller 304 communicates a pulse over signal lines 306 and 308 to receiving AMR (e.g., via a transmitter via any conventional AMR technology. In one implementation, microcontroller 304 includes sleep mode logic to extend life of the batter(ies) 206.

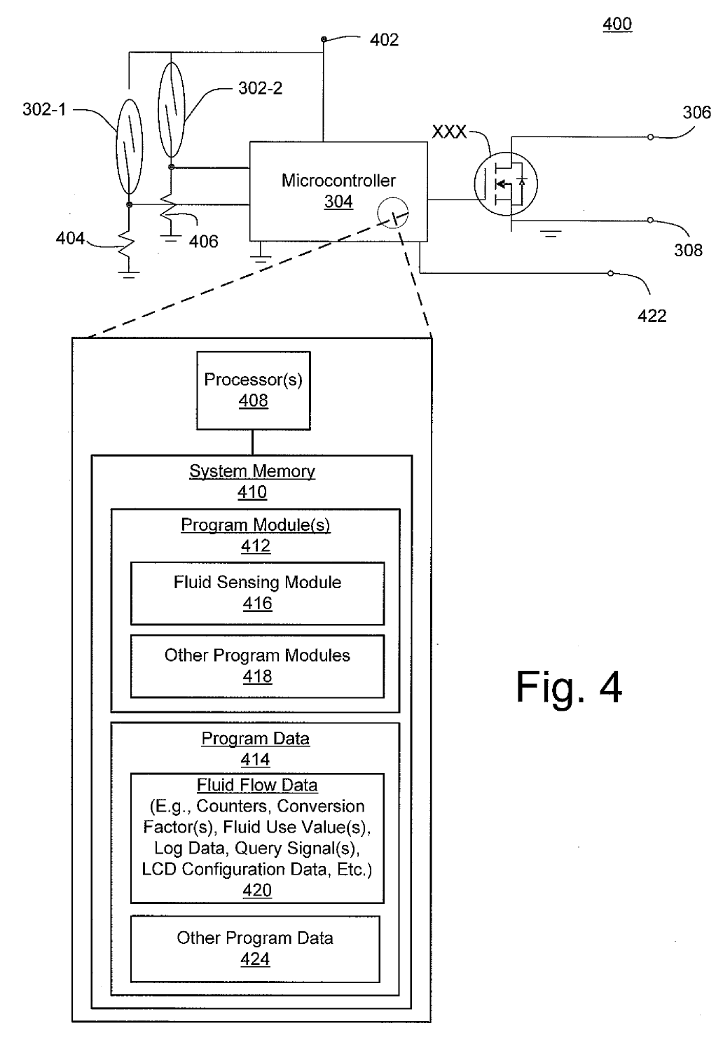

FIG. 4 shows an exemplary circuit diagram 400 of an AMR-enabled fluid meter 200 of FIGS. 2 and 3, according to one embodiment. For purposes of exemplary description, aspects of FIG. 4 are described with respect to aspects of FIGS. 1 through 3. In the description, the left-most numeral of a drawing component indicates the particular drawing where the component was first introduced. Referring to FIG. 4, microcontroller 304 is an integrated circuit that provides a universal interface to AMR. Microcontroller 304 includes, for example, a processor 408 coupled to tangible system memory 410 representing volatile random access memory (RAM) and non-volatile read-only memory (ROM) such as EPROM, EEPROM, Flash memory, etc. System memory 410 comprises program modules 412 and program data 414. In this implementation, program modules 412 include, for example, fluid sensing module 416 and “other program modules” 418 such as an Operating System (OS) to provide a runtime environment for controlling switches 302 (e.g., switches 302-1 and 302-2, data communication logic, etc.

In this implementation, there are two magnetic switches 302; switches 302-1 and 302-2. In this implementation, both switches are Reed switches/sensors. The Reed switches are coupled to an energy source, for example, to positive battery voltage 402. To minimize current and extend battery life in system 400, one of the switches 302 (e.g., sensor 302-1) is a “wake-up” and count sensor, and both Reed switches 302 are coupled to high impedance resistors 404 and 406. As rotating disc magnet 108 rotates, each rotation indicating a per-unit volume of fluid passing through fluid meter 200, a magnetic pole periodically passes by Reed switches 302-1 and 302-1. When such a magnetic pole is not sensed by a switch sensor 302, the Reed switch 302 is open, effectively directing microprocessor 304 to enter sleep mode and conserve energy. Responsive to sensing the magnetic pole, a respective Reed switch closes, causing microcontroller 304 to wake-up from sleep mode and begin sensing module 416 processing. Such processing includes, for example, incrementing a count indicating a number of magnetic rotations of rotating disc magnet 108 over a configurable period. This count takes into consideration of the two-switch 302 configuration (i.e., for each rotation, each switch 302 increments the count), and as described in the following paragraph, also addresses a single switch 302 configuration in the event that one of the two switches 302 fails. For purposes of exemplary illustration, such a count is shown as a respective portion of fluid flow data 420. Using a preconfigured conversion factor based on the arbitrary fluid flow capabilities of fluid meter 200, sensing module 416 converts the count to total fluid use values for a designated and configurable period. Sensing module 416 persists such total fluid use value(s) in a respective portion of fluid flow data 420.

In this implementation, the two switch 302 configuration shown in circuit diagram 400 provides switch failover redundancy of the fluid flow sensing capabilities of fluid meter 200. Specifically, fluid sensing module 416 detects when a switch 302 (e.g., 302-1 or 302-2) fails, or otherwise malfunctions. For example, when input from only a single switch 302 is detected for a configurable threshold number of rotations of rotating disc magnet 208, fluid sensing module 416 determines that only one switch 302 is operational, reconfiguring fluid flow conversation operations accordingly. Specifically, from the point in time that it is determined that only one of the two sensors 302 is operational, fluid sensing module 416 calculates fluid volume flows based on a input from only a single operational switch 302 (i.e., one count maps to a full rotation of rotating magnetic disc 108). In this manner, use of multiple magnetic sensing switches 302 in fluid meter 200 provides redundancy to its fluid flow calculations, offering reliable meter readings even in view of failure or malfunction of one of magnetic switches 302. Analogously, fluid sensing module 416 detects if a previously failed or malfunctioning sensor 304 comes back on-line (i.e., begins to again provide input to fluid sensing module 416; input pertaining to rotations of rotating disc magnet 108), responsive to which fluid sensing module 416 reconfigures fluid flow calculations to according to input from both operational switches 302.

Sensing module 416 uses arbitrary configurable criteria to determine whether to send a pulse to the AMR indicating the stored total fluid use value. According to such criteria, sensing module 416 turns on transistor 408 for a configurable amount of time, allowing the pulse to be interrogated via AMR over signal lines 306 and 308. There are multiple known techniques for AMR to interrogate such a pulse. Such techniques include, for example, receipt of an interrogation signal from a computer or data collection device, radio frequency-based AMR, fixed network AMR, etc. In this manner, fluid meter 200 collects fluid flow data 420 and selectively communicates at least a subset of such data over signal lines 306 and 308 to AMR for analysis and presentation to a user.

### Exemplary Tamper and Reverse Fluid Flow Detection

Placing a strong magnet over a fluid meter generally tampers with the proper functionality of a fluid measuring meter that measures flow via electromagnetic induction. To identify such tampering, and in this implementation, fluid meter 200 includes the second sensor (e.g., Reed switch 302-2) placed relative to the first sensor (e.g., Reed switch 302-1) so that only one sensor at a time is closed due to the rotating disc magnetic field associated with rotating disc magnet 108. In this implementation, if a strong magnet is proximally located to meter 200, both switches 302-1 and 302-2 will be closed. In this scenario, microcontroller 304 will not receive any “wake up” signals for some amount of time. In this implementation, if microcontroller 304 does not receive a wake-up signal for a configurable threshold amount of time, microcontroller 304 automatically wakes-up to evaluate status of switches 302-1 and 302-2. If both sensors are closed, microcontroller 304 activates tamper line 422 to indicate that the fluid flow counts have been tampered. Tamper line 422 can be interrogated via AMR device(s) using any of multiple known such interrogation techniques. In another implementation, fluid meter 200 detects tampering by sensing the direction of magnet 108 rotation using multiple sensors 302 to determine if the water flow to the meter has been reversed.

### Exemplary Procedure

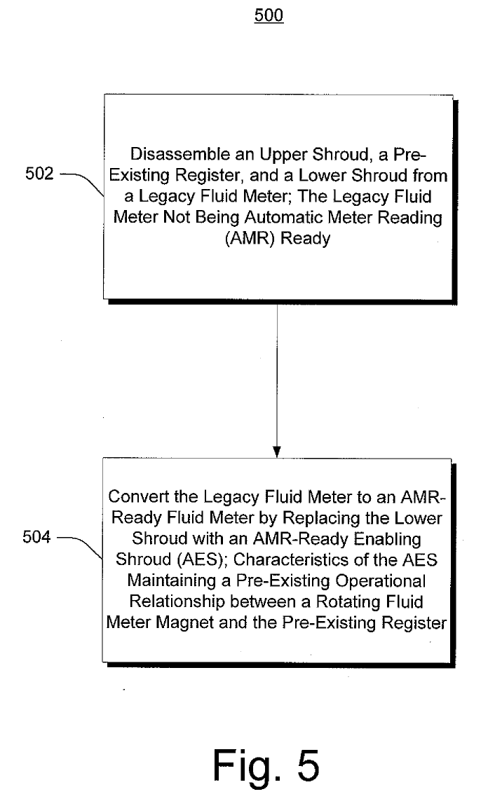

FIG. 5 shows an exemplary procedure 500 for generating a fluid meter 200 with a universal AMR interface from a conventional legacy fluid meter, according to one embodiment. For purposes of exemplary illustration and description, the operations of procedure 500 are described with respect to aspects and components of FIGS. 1 through 4. In the description, the left-most numeral of a component reference number indicates the particular figure where the component was first introduced. Referring to FIG. 5, operations at block 502 disassemble an upper shroud 102 (FIG. 1), a pre-existing mechanical or electrical register 104, and a lower shroud 106 from a legacy fluid meter 100. The legacy fluid meter 100 is not configured to interface with any Automatic Meter Reading (AMR) device. Operations of block 504 convert the legacy fluid meter 102 and AMR-ready fluid meter 200 (FIG. 2) by replacing the lower shroud 106 with an AMR-ready Enabling Shroud (AES) 202.

The AES 202 comprises at least one magnetic switch (e.g., magnetic switch 302 of FIG. 3) coupled to a microcontroller (please see microcontroller 304 of FIG. 3) to generate pulse data on signal lines (e.g., signal lines 306 and 308 of FIG. 3) for interrogation by a conventional AMR device. The pulse data indicates a total amount of fluid flow that has passed through the fluid meter 200 over a configurable period. To determine this total amount of fluid flow, the at least one magnetic switch wakes up microcontroller 304 responsive to sensing north and south magnetic poles from rotating disc magnet 108. Upon activation, the microcontroller increments a counter for each north and south pole that has been sensed. The microcontroller is configured to utilize this counter calculate the total amount of fluid flow based on a predetermined per-unit fluid volume that passes through the fluid meter per rotation of the rotating disc magnet 108, and therefrom, generate the pulse data for an operatively coupled AMR device. In view of the above, a non-AMR-capable legacy fluid meter 100 has been converted to an AMR-ready fluid meter 200.

Additionally, characteristics of the AES 202 maintain a pre-existing operational relationship between a rotating fluid meter magnet 108 in the fluid meter and the pre-existing register 104. As a result, the pre-existing register 104 is still configured (as it was in the legacy meter 100) to determine fluid flow information based on rotations of the rotating disc magnet to present fluid flow information to a viewer.

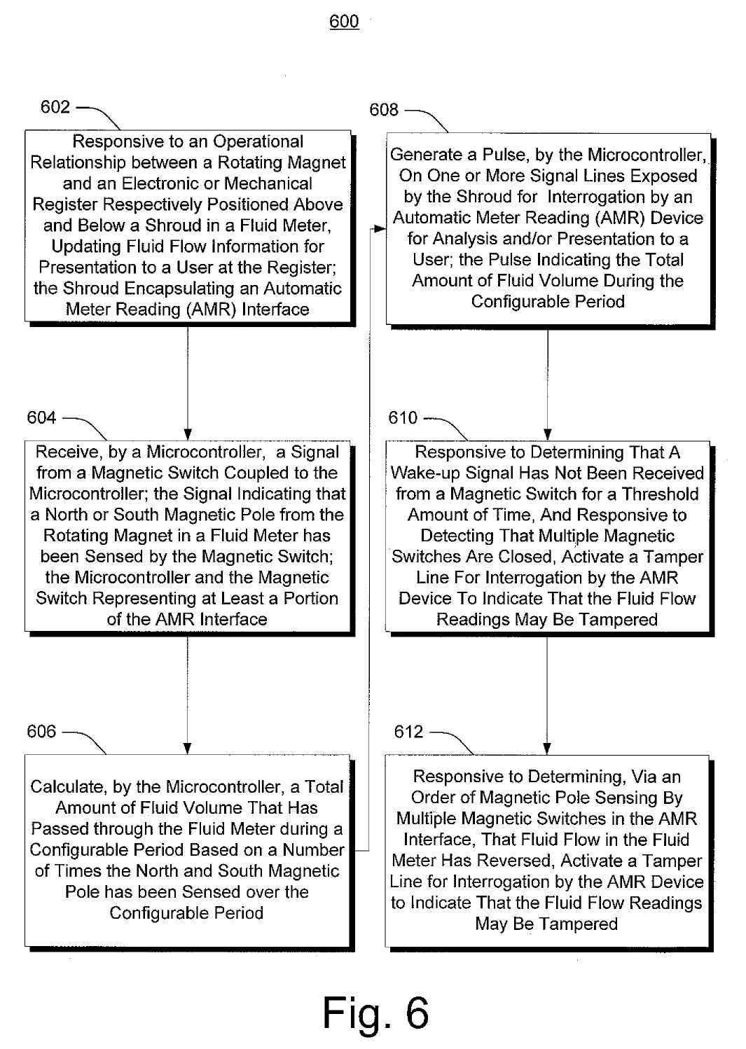

FIG. 6 shows another exemplary procedure 600 for a universal AMR interface for fluid centimeters, according to an embodiment. For purposes of exemplary illustration and description, the operations of procedure 600 are described with respect to aspects and components of FIGS. 1 through 5. In the description, the left-most numeral of a component reference number indicates the particular figure where the component was first introduced. Referring to FIG. 6, operations at block 602 are responsive to an operational relationship between a rotating disc magnet and a register in an AMR-ready fluid meter 200 (FIG. 2). This operational relationship is defined by positioning of the rotating disc magnet and the register being respectively positioned below and above an AMR-enabling shroud (AES; please see AES 202 of FIG. 2). As a result of this operational and positional relationship, fluid flow information is updated at the register for presentation to a viewer, wherein the fluid flow information is based on rotations of the rotating disc magnet.

Operations of block 604 receive, by a microcontroller (e.g. a microcontroller 304 of FIG. 4), a signal from a magnetic switch (e.g., a respective magnetic switch 302 of FIG. 4) coupled to the microcontroller. The signal indicates that a north or south magnetic pole generated by a rotating disc magnet (e.g., rotating disc magnet 108 of FIG. 2) in a fluid meter has been sensed by the magnetic switch. In this implementation, the magnetic switch and its respective coupling to the microcontroller represents at least a portion of the AMR interface encapsulated by the AES.

Operations of block 606 calculate, by the microcontroller, a total amount of fluid volume that has passed through the fluid meter 200 (e.g., fluid meter 200 FIG. 3) during a configurable amount of time (“period”). This total amount of fluid volume, or flow, is based on a per-unit volume of fluid flow associated with each rotation of the rotating disc magnet, and therefore, the number of times that the North and South Poles associated with rotating disc magnet are sensed by the magnetic switch over the configurable amount of time. Operations at block 608 generate a pulse, by the microcontroller, on one or more signal lines exposed by the AES (e.g., please see signal lines 306 and 308 of FIG. 4). An operatively coupled AMR device interrogates such signal lines to determine the pulse data for subsequent analysis and/or presentation to the user.

Operations of block 610, responsive to determining that a wake-up signal has not been received from a magnetic switch for threshold amount of time, the microprocessor evaluates whether each of multiple magnetic switches in the AES are closed, for example, under the influence of a strong magnetic field. Upon determining that the magnetic switches are closed, the microprocessor activates a tamper line (e.g., please see temper line 422 of FIG. 4) for interrogation by an AMR device to indicate to the user of the device that the fluid flow readings from the fluid meter may be tampered. Operations of block 612 determine, by the microprocessor, that the fluid flow in the fluid meter has reversed (e.g., via an order of magnetic pole sensing by multiple magnetic switches in the AES). Responsive to this determination, the microprocessor activates the tamper line for interrogation by the AMR device. Such activation indicates to a user of the AMR device that the fluid flow readings from the fluid meter may be inaccurate.

### Conclusion

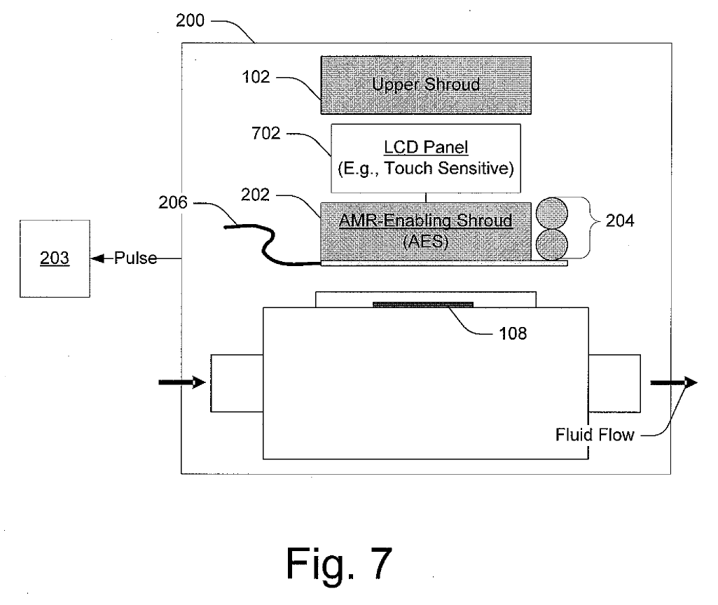

Although the above sections describe an automatic meter-reading interface for fluid sensing meters in language specific to structural features and/or methodological operations or actions, the implementations defined in the appended claims are not necessarily limited to the specific features or actions described. For example, FIG. 7 shows an exemplary alternative implementation of AMR-ready fluid meter 200 of FIG. 2, according to one embodiment. Specifically, this alternate implementation of fluid meter 200 replaces pre-existing register 104 of the legacy meter 100 (FIG. 1) with a fully functioning electronic register to present fluid flow information to a user. In one implementation, for example, AES 202 is operatively coupled to an LCD panel 702 to present fluid flow information to the user. In one implementation, computer-program logic in a program module 412 (FIG. 4) implements at least a subset of operations of the LCD panel. Such operations include, for example, selective presentation of information responsive to a user touching the LCD panel or at predetermined and configurable time intervals. In one implementation, for example, the LCD panel presents one or more portions of fluid flow data 420 (FIG. 4) for viewing for a configurable amount of time (e.g., five seconds, etc.) responsive to being touched by a user. In another implementation, the LCD panel provides fluid usage information over configurable periods (e.g., a previous number of hours, days, months, years, etc.) responsive to a configurable number of times that the user has touched the LCD panel. In another example, the fluid meter of FIG. 7 represents a completely new fluid meter, and not a legacy meter retrofit with AES 202. Accordingly, the specific features and operations for automatic meter-reading interface for fluid sensing meters described above are exemplary forms of implementing the claimed subject matter.

1. A fluid metering sensing system component, the fluid metering sensing system component comprising:
an Automatic Meter Reading (AMR) enabling shroud (AES) for positioning below a register and above a rotating disc magnet in a fluid meter, the AES being configured for positioning to maintain an operational relationship between the rotating disc magnet and the register, the AES comprising at least one magnetic switch coupled to a microcontroller to calculate a total volume of fluid that has passed through the fluid meter over a configurable period based on a periodically sensed magnetic field from the rotating disc magnet; and
wherein the microcontroller is further configured to generate a pulse indicating the total volume of fluid for interrogation by an AMR device, information associated with the pulse being for one or more of analysis and presentation of associated data to a user.

2. The fluid metering sensing system component of claim 1, wherein the AES replaces a lower shroud in a non-AMR-ready fluid meter, replacement of the lower shroud in the fluid meter to modify the non-AMR-ready fluid meter into an AMR-ready fluid meter independent of replacing the register.

3. The fluid metering sensing system component of claim 1, wherein electronics, sensors, and an energy source encapsulated in the AES are over-molded in modular form to waterproof the AES, the AES is plastic.

4. The fluid metering sensing system component of claim 1, wherein the at least one magnetic switch is a Reed switch or based on uses Hall effects.

5. The fluid metering sensing system component of claim 1, wherein information associated with pulses indicating total volume usage over time are persisted in a computer-readable data storage medium for presentation to a user on demand or at configurable time intervals.

6. The fluid metering sensing system component of claim 1, wherein the register is a pre-existing register.

7. The fluid metering sensing system component of claim 1, wherein the AES comprises two magnetic switches coupled to the microcontroller to provide failover redundancy to fluid flow calculations, and wherein the microcontroller comprises computer-program instructions executable by a processor for:
detecting when each of the two magnetic switches providing input;
responsive to the detecting, calculating the total volume of fluid based on input from each of the two magnetic switches;
determining that only one switch of the two magnetic switches is providing input for a configurable threshold amount of time; and
responsive to the determining, calculating the total volume of fluid based on input from the one switch.

8. The fluid metering sensing system component of claim 1, wherein the AES comprises two magnetic switches coupled to the microcontroller, and wherein the microcontroller comprises computer-program instructions executable by a processor for:
automatically waking-up from a sleep mode responsive to passage of a configurable amount of time without receiving a wake-up signal from at least one switch of the two magnetic switches; and
responsive to automatically waking up from the sleep mode:
evaluating status of each switch of the two magnetic switches to determine if the switch is closed; and
responsive to determining that each of the two magnetic switches are closed, activating a tamper line to indicate that fluid flow calculations in the fluid meter are tampered; and
wherein the tamper line is for interrogation by the AMR device to indicate to a user to further evaluate validity of fluid flow readings from the fluid meter.

9. The fluid metering sensing system component of claim 1, wherein the AES comprises two magnetic switches coupled to the microcontroller, and wherein the microcontroller comprises computer-program instructions executable by a processor for:
sensing direction of rotation of the rotating disc magnet using the two magnetic switches;
detecting that the direction of rotation has reversed; and
responsive to the detecting, activating a tamper line to indicate that fluid flow calculations in the fluid meter are tampered; and
wherein the tamper line is for interrogation by the AMR device to indicate to a user to further evaluate validity of fluid flow readings from the fluid meter.

10. A tangible computer-readable medium comprising computer-program instructions executable by a processor in a microcontroller, the computer-program instructions when executed by the processor for implementing operations comprising:
receiving a signal from at least one magnetic switch coupled to the microcontroller, the signal indicating that a North or South magnetic pole from a rotating disc magnet in a fluid meter has been sensed;
responsive to receiving the signal:
calculating a total amount of fluid volume that has passed through the fluid meter during a configurable period;
generating a pulse on one or more signal lines to indicate the total amount of fluid volume during the configurable period, the one or more signal lines are for interrogation by an automatic meter reading device for one or more of analysis and presenting information associated with a total amount of fluid volume during the configurable period to user; and
wherein the microcontroller and the at least one magnetic switch are for encapsulation in a component, the component for positioning between a register and a rotating disc magnet on the fluid meter, the component being configured to maintain an operational relationship between the rotating disc magnet and the register to present at least an indication of an amount of fluid flow through the fluid meter to a user.

11. The tangible computer-readable medium of claim 10, wherein the at least one magnetic switch is a Reed switch or a switch that uses Hall effects to periodically sense the North and South magnetic poles.

12. An Automatic Meter Reading (AMR) ready fluid metering system, the AMR-ready fluid metering system being generated by operations comprising:
disassembling an upper shroud, a register, and a lower shroud from a non-AMR-ready legacy fluid meter;
replacing for the lower shroud with an AMR-ready enabling shroud (AES);
reassembling the register and upper shroud in conjunction with the AES such that a rotating disc magnet configured to turn based on a per-unit of fluid flow maintains coupling to the register to preserve operability of the register; and
wherein the disassembling, the replacing, and the reassembling convert the non-AMR-ready fluid meter into the AMR-ready fluid metering system.

13. The AMR-ready fluid metering system of claim 12, wherein electronics, sensors, and an energy source encapsulated in the AES are over-molded in modular form to waterproof the AES, the AES is plastic.

14. The AMR-ready fluid metering system of claim 12, wherein the AES is configured to detect tampering due to a strong magnetic field, the AES being further configured to provide an indication of such tampering to a user of an AMR device.

15. The AMR-ready fluid metering system of claim 12, wherein the AES is configured to determine direction of rotating disc magnet rotation to identify fluid flow measurement tampering, the AES being further configured to provide an indication of such tampering to a user of an AMR device.

16. The AMR-ready fluid metering system of claim 12, wherein the AES is configured to conserve energy at predetermined intervals or an interval of inactivity.

17. The AMR-ready fluid metering system of claim 12, wherein:
the AES comprises at least one magnetic switch coupled to a microcontroller, the at least one magnetic switch being configured to periodically sense a magnetic field from the rotating disc magnet, responsive to detecting the magnetic field, the at least one magnetic switch waking the microcontroller from a sleep mode;
the microcontroller comprising a processor coupled to a memory, the memory comprising computer-program instructions executable by the processor, the computer-program instructions when executed by the processor for performing operations comprising:
responsive to being woken-up:
calculating a total amount of fluid volume that has passed through the AMR-ready fluid metering system during a configurable period;
generating a pulse on one or more signal lines to indicate the total amount of fluid volume during the configurable period; and
wherein the one or more signal lines are for interrogation by an AMR device for one or more of analysis and presenting information associated with a total amount of fluid volume during the configurable period to user.

18. The AMR-ready fluid metering system of claim 17, wherein the at least one magnetic switch is a Reed switch.

19. The AMR-ready fluid metering system of claim 17, wherein the at least one magnetic switch is based on Hall effects.

20. The AMR-ready fluid metering system of claim 17, wherein the microcontroller is programmable to generate a pulse for compatibility to multiple different brands of fluid meters and AMR processing units.

21. An AMR-ready fluid metering sensing system component, the fluid metering sensing system component comprising:
an Automatic Meter Reading (AMR) enabling shroud (AES) for replacing a pre-existing register and for positioning above a rotating disc magnet in a fluid meter, the AES comprising at least one magnetic switch coupled to a microcontroller to calculate a total volume of fluid that has passed through the fluid meter over a configurable period based on a periodically sensed magnetic field from the rotating disc magnet, the microcontroller being coupled to an LCD to present information associated with the total volume of fluid to a user, the LCD representing an electronic register; and
wherein the microcontroller is further configured to generate a pulse indicating the total volume of fluid for interrogation by an AMR device, information associated with the pulse being for one or more of analysis and presentation of associated data to a user.
